(19) United States
(12) Patent Application Publication
(10) Pub. No.: US 2016/0104244 A1
(43) Pub. Date: Apr. 14, 2016

(54) System and Method of Portfolio Allocation Comprising One or More Alternative Investments

(71) Applicant: Stratosphere, LLC, Bryn Mawr, PA (US)

(72) Inventor: Stephen Todd Walker, Bryn Mawr, PA (US)

(73) Assignee: Stratosphere, LLC, Bryn Mawr, PA (US)

(21) Appl. No.: 14/811,424

(22) Filed: Jul. 28, 2015

Related U.S. Application Data
(60) Provisional application No. 62/029,715, filed on Jul. 28, 2014.

(51) Int. Cl. G06Q 40/06

(52) U.S. Cl. CPC G06Q 40/06

(57) ABSTRACT

A system and method for a modern portfolio allocation, which incorporates one or more of an alternative investment asset, comprises an investment policy statement, a plurality of alternative investments, one or more risk management variables, a behavioral finance analysis, and one or more optimization tools. The system and method are configured to provide a tripartite asset allocation comprised of assets that are not highly correlated. A system for allocating assets within an investment portfolio comprises: one or more data storage units; an investment policy statement, including a risk tolerance level; one or more analysis engines in communication with the data storage unit, wherein the investment policy statement is analyzed by one or more of the analysis engines, thereby generating a portfolio construction comprised of a tripartite asset allocation of fixed income, equities, and one or more alternative investments.

### CROSS REFERENCE TO RELATED APPLICATIONS

The present application claims the benefit of earlier filed U.S. Provisional patent Application No. 62/029,715, filed on Jul. 28, 2014, the contents of which are hereby incorporated by reference in their entirety.

### BACKGROUND

Over the past four decades, asset allocation was thought to be the Holy Grail to investing. It has been widely accepted that “93.6 percent” of performance was because of asset allocation. However, few investment professionals questioned how this conclusion was derived. Multiple definitions of asset allocation sprang up along the way but failed to address alternative investments. The focus has primarily been with stocks, bonds, and cash. In “Determinants of Portfolio Performance,” Brinson, Hood, and Beebower examined 91 large pension plans over 1974-1983 and found that asset allocation is far more important than security selection or market timing. They found that investment policy dominates 93.6 percent of the variation in total plan return. The studies were flawed and failed to incorporate alternative investments. Alternative investments typically have a low and sometimes negative correlation with stocks and bonds. They are an entirely different asset class and for the most part, act differently. Security selection and tactical asset allocation (formerly called “market timing” by Brinson and others) are both more important than one would think with alternative investments.

Presently, there is no prudent or effective way to invest in alternative investments. There is also lacking any methodology for asset selection that considers that alternative investments move in waves (cycles, patterns, and trends). There is a need for an asset allocation method for asset selection based on alternatives that considers behavioral finance, measures risk for alternative investments, and tracks alternative investments in one venue.

### SUMMARY

Described herein is a system and method for a modern portfolio allocation, which incorporates one or more of an alternative investment asset. The present invention solves the problems of traditional investment and portfolio allocation methodology by considering behavioral finance, utilizing modern risk factors, and considers the cycles, patterns and trends of alternative investment assets over time.

The system and method described herein comprise an investment policy statement, a plurality of alternative investments, one or more risk management variables, a behavioral finance analysis, and one or more optimization tools. The system and method are configured to provide a tripartite asset allocation comprised of assets that are not highly correlated.

The purpose of the present invention is twofold. First, alternative investments are used to diversify. Diversification is a means to lower risk or standard deviation. It is a common risk management tool. The objective is to have minimal covariance with the securities in a portfolio. Covariance is simply a measure of how much or how little two variables change together. By diversifying and owning different types of securities that do not move in lockstep together, risk will most likely be reduced. First, alternative investments are mostly illiquid. There is often an illiquidity risk premium. Alternative investments offer better diversification than traditional asset classes such as equities of fixed income. Alternative investments can also be long and short at the same time as seen with hedge funds. To an extent, alternative investments enable an investor to better manage risk. Second, returns are can be increased using alternative investments instead of all equity, fixed income, or a combination of only equity and fixed income through section and timing.

In one embodiment, the system is configured with 5 key aspects in mind. First, a diversified portfolio comprised of assets that are not highly correlated. Second, alternative investments are carefully selected and added to stock and bond portfolios in order to create a more diversified portfolio. Third, the allocation is analyzed and adjusted as necessary to minimize risk yet increase rate of return on investment. Fourth, tactical and strategic asset allocation are used. In other words, both short-and long-term strategies are used with the asset allocation model. Fifth, risk measurements are used to achieve better expectations with investors

Using merely equities and fixed income as the dominant part of an asset allocation while ignoring alternative investments altogether will not produce as compelling returns as a portfolio that includes alternative investments. In addition, security selection and timing play an important role with alternative investments which can lead to better performance and with less risk. In addition, using advanced risk measurements such as mVar and cVar will be more useful with rogue waves or extraordinary market changes.

While traditional asset allocation models utilized a quantitative tool called Mean Variance Optimization (MVO). MVO revolves around the efficient frontier curve. The more the risk incurred, the higher the rate of return, while the antithesis is true; the less risk one takes the lower the return. An investor makes a portfolio allocation with the goal to maximize expected returns while selecting a certain level of risk. MVO was not designed for alternative investments. Worse yet, MVO can be problematic with alternative investments; MVO does not take into account the “tail risks” that investors abhor like rogue waves where they can lose a lot of money. Modern Portfolio Allocation considers tail risks.

According to one aspect of the present invention, a system for allocating assets within an investment portfolio comprises: one or more of a data storage unit for storing data associated with a plurality of assets, including equities, fixed income, and alternative investment; an investment policy statement, wherein data includes an assembly of investment criteria including a risk tolerance level; one or more analysis engines in communication with the data storage unit, each analysis engine configured to evaluate criteria of the investment policy statement in order to identify an allocation of assets, wherein the analysis engines comprise a Fibonacci analysis engine, a risk measurement analysis engine, and a behavioral finance analysis engine; a client terminal for input and display of information associated with the investment policy statement; and a processing unit in connection with the data storage and the client terminal, wherein information from the investment policy statement is analyzed by one or more of the analysis engines, thereby generating a portfolio construction comprised of a tripartite asset allocation of fixed income, equities, and one or more alternative investments. In another embodiment, the system comprises means for storing the portfolio construction as an electronic record in a database for later retrieval, refinement and adjustment.

According to another aspect of the present invention a method for allocating assets within an investment portfolio comprises: generating an investment policy statement; assembling, based on criteria identified in the investment policy statement, a selection of asserts that are not highly correlated; selecting from one or more of an alternative investment type for inclusion in the asset allocation; applying one or more modern risk measurements, wherein risk measurements are calculated; performing a behavioral risk analysis, wherein risk analysis depends, in part, on behavioral data gathered from third party sources in order to assess market sentiment and market volatility; applying a Fibonacci analysis; and compiling the results into a portfolio construction, thereby generating a tripartite asset allocation, wherein the portfolio construction may be presented in graphical display on a client terminal and may be stored in a database as an electronic record for later retrieval.

According to another aspect of the present invention, a non-transitory computer-readable medium having recorded thereon a program that causes a computing device to execute a method for asset allocation within an investment portfolio, the steps in the method comprises: receiving investment criteria identified in an investment policy statement; assembling, based on criteria identified in the investment policy statement, a selection of asserts that are not highly correlated; selecting from one or more of an alternative investment type for inclusion in the asset allocation; applying one or more modern risk measurements, wherein risk measurements are calculated; performing a behavioral risk analysis; applying a Fibonacci analysis; and compiling the results into a portfolio construction, thereby generating a tripartite asset allocation, wherein the portfolio construction is presented in graphical or tabulated form on a display unit associated with the computing device.

In one embodiment the system and method operate in an exemplary network environment including one or more of a client terminal, one or more of a server, wherein the terminal and server communicate over a LAN, WLAN, or WAN network. In one embodiment, the client terminal comprises a computing device, a laptop computer, desktop computer, a tablet, a smartphone, portable terminal, or any other suitable device. In one embodiment, the server is a server device connected to the client via a LAN or WAN, or may be a cloud-based server. In another embodiment, the system comprises means of collecting and storing information from third party data providers, such as data utilized by one or more of the analysis engines of the system.

In one embodiment, the system and method provide a tool for institutions, financial advisors, or investors to help make decisions to add or remove various alternative investments to an existing investment portfolio, with the goal of lowering risk and increasing returns.

### BRIEF DESCRIPTION OF THE FIGURES

The utility of the embodiments of the invention will be readily appreciated and understood from consideration of the following description of the embodiments of the invention, when viewed in connection with the accompanying drawings:

FIG. 1 shows an overview of an exemplary system according to one embodiment of a method for asset allocation.

FIG. 2 shows an exemplary process flow diagram illustrating embodiments of a method for generating an asset allocation.

FIGS. 3-1, 3-2, 3-3 and 3-4 show a table comprised of historical data used for asset analysis by one or more of the analytic modules of the system.

FIG. 4 illustrates an exemplary tripartite asset allocation index according to one embodiment of the present invention.

FIG. 5 shows an exemplary asset allocation according to one embodiment of the present invention.

FIGS. 6-1 and 6-2 show an exemplary portfolio comprised of a tripartite asset allocation and indicting risk, return and Sharpe ratio, according to one embodiment of the present invention.

FIGS. 7-1 and 7-2 show an exemplary Fibonacci analysis according to one embodiment of the invention.

FIGS. 8A and 8B shows exemplary Fibonacci analysis-detailing projection and retracement—according to one embodiment of the invention.

### DETAILED DESCRIPTION OF THE INVENTION

Described herein is a system and method for asset allocation in an investment portfolio. In describing different aspects of the invention and the environment in which the invention operates the following terms are used. These terms are used for explanation purposes only and are not intended to limit the scope for any aspect of the invention.

### Definitions:

Alternatives, as used herein refer to investments comprising real estate, commodities, private securities, venture capital, leverage buyout, managed futures, and hedge funds. “Alternatives” and “Alternative investments” may be used interchangeably throughout.

Behavioral Finance, as used herein refers to a methodology to explain market anomalies, wherein it is assumed that the information structure and the characteristics of market participants systematically influence individuals' investment decisions as well as market outcomes. This methodology is the basis of an analytics module within the system of the present invention.

Fibonacci, as used herein refers to a method of analysis that utilizes the principles of Fibonacci mathematics, based on the principle of a simple numerical sequence that starts with 0, and each new number in the sequence is simply the sum of the two before it, for example: 0, 1, 1, 2, 3, 5, 8, 13, 21, 34, 55, 89, 144. The ratio of each successive pair of numbers in the sequence approximates phi (1.618 . . . ), as 5 divided by 3 is 1.66, and 8 divided by 5 is 1.60. When used in technical analysis, the golden ratio (two quantities are in the golden ratio if their ratio is the same as the ratio of their sum to the larger of the two quantities) is typically translated into three percentages: 38.2%, 50% and 61.8%. However, more multiples can be used when needed, such as 23.6%, 161.8%, 423% and so on. There are four primary methods for applying the Fibonacci sequence to finance: retracements, arcs, fans and time zones. Fibonacci analysis is the basis of an analytics module within the system of the present invention.

Modern Portfolio Allocation as used herein is a method of investing that incorporates alternative investments into a portfolio in order to lower risk and increase returns, with investment selection based, in part, on the principle that alternative investments move in patterns, trends, and cycles (“Wave Theory”). MPA revolves around tactical (short term investing) as well as strategic (long term investing) and can use liquid or illiquid alternative investments to diversify. MPA utilizes new risk measurements such as Value at Risk (VaR), Modified Value at Risk (MVaR), Conditional Value at Risk (CVaR), and M-CVaR) as well as traditional risk measurements, such as Sharpe Ratio, Treynor Ratio, and Sortino Ratio.

In one embodiment a method for asset allocation comprises: generating an investment policy statement; assembling, based on the investment policy statement, a selection of asserts that are not highly correlated; selecting from one or more of a an alternative investment types for inclusion in the asset allocation; calculating a risk tolerance and incorporating one or more modern risk measurements; performing a behavioral risk analysis; applying a Fibonacci analysis; and compiling the results into a portfolio construction, thereby generating a tripartite asset allocation.

### Exemplary Tripartite Portfolio Allocation

The utility of the present invention is demonstrated in the Example Portfolios presented herein. By way of illustration, if an investor elected to have 20% in equities and 20% in fixed income but distribute the rest or invest 60% in alternative investments, how would that affect returns? For illustrative purposes, one could equally weight six of the main alternative investments by allocating 10% to each of the six primary alternative investments to comprise the 60% allocation to alternative investments. The six alternative investments used in this example are as follows: NAREIT, S&P GSCI, Cambridge US Venture Capital, Cambridge US Private Equity, Barclays CTA Index, and the HFRI Fund Weighted Composite, shown in Table 1.

TABLE 1

| | BarCap | S&P 500 | NAREIT | | CAMB US | CAMB US | BARC CTA | HFRI Fund | |
|---|---|---|---|---|---|---|---|---|---|
| | AggreateBnd | Composite | Composite | S&P GSCI | Venture Cap | Private Eqty | Index | Wghtd Comp | |
| | Weight | | | | | | | | Total |
| Date | 20.00% | 20.00% | 10.00% | 10.00% | 10.00% | 10.00% | 10.00% | 10.00% | Return |
| 1991 | 16.00 | 30.23 | 35.68 | −6.13 | 20.58 | 9.57 | 3.73 | 32.19 | 18.81 |
| 1992 | 7.40 | 7.49 | 12.18 | 4.42 | 10.61 | 16.38 | −0.91 | 21.22 | 9.37 |
| 1993 | 9.75 | 9.97 | 18.55 | −12.33 | 21.87 | 21.89 | 10.37 | 30.88 | 13.07 |
| 1994 | −2.92 | 1.33 | 0.81 | 5.29 | 20.07 | 16.37 | −0.65 | 4.10 | 4.28 |
| 1995 | 18.47 | 37.20 | 18.31 | 20.33 | 47.81 | 27.48 | −13.64 | 21.50 | 23.21 |
| 1996 | 3.63 | 23.82 | 35.75 | 33.92 | 30.18 | 23.20 | 9.12 | 21.10 | 20.82 |
| 1997 | 9.65 | 31.83 | 18.86 | −14.07 | 54.40 | 39.63 | 10.89 | 16.79 | 20.95 |
| 1998 | 8.69 | 28.34 | −18.82 | −35.75 | 35.89 | 11.70 | 7.01 | 2.62 | 7.67 |
| 1999 | −0.82 | 20.89 | −6.48 | 40.92 | 319.77 | 50.51 | −1.19 | 31.29 | 47.50 |
| 2000 | 11.63 | −9.03 | 25.89 | 49.74 | −17.75 | −14.24 | 7.86 | 4.98 | 6.17 |
| 2001 | 8.44 | −11.85 | 15.50 | −31.93 | −34.05 | −6.74 | 0.84 | 4.62 | −5.86 |
| 2002 | 10.26 | −21.97 | 5.22 | 32.07 | −29.63 | −7.59 | 12.36 | −1.45 | −1.24 |
| 2003 | 4.10 | 28.36 | 38.47 | 20.72 | 2.18 | 26.96 | 8.69 | 19.55 | 18.15 |
| 2004 | 4.34 | 10.74 | 30.41 | 17.28 | 11.06 | 24.20 | 3.30 | 9.03 | 12.5 |
| 2005 | 2.43 | 4.83 | 8.29 | 25.55 | 14.71 | 30.94 | 1.71 | 9.30 | 10.50 |
| 2006 | 4.33 | 15.61 | 34.02 | −15.09 | 14.99 | 29.73 | 3.54 | 12.89 | 12.00 |
| 2007 | 6.97 | 5.48 | −17.83 | 32.67 | 11.09 | 10.83 | 7.64 | 9.96 | 7.93 |
| 2008 | 5.24 | −36.58 | −37.84 | −46.49 | −17.36 | −23.63 | 14.09 | −19.02 | −19.29 |
| 2009 | 5.93 | 25.92 | 27.80 | 13.48 | 6.28 | 21.74 | −0.10 | 19.98 | 15.29 |
| 2010 | 6.54 | 15.06 | 27.56 | 9.02 | 18.51 | 21.45 | 7.05 | 10.49 | 13.73 |
| Average | 7.00 | 10.88 | 13.62 | 7.18 | 27.06 | 16.52 | 4.59 | 13.10 | 11.78 |

By adding a mix of six different alternative investments, the average return went from +8.94% to +11.78%. The lowest return was Barclays CTA or managed futures with 4.59%. While this number is the lowest, it is most interesting to note the importance of this alternative investment. During 2000, 2001, 2002, the S&P500 index lost −9.03%, −11.85%, and −21.97%. Managed futures, on the other hand, produced +7.86%, +0.84%, +12.36% during these extremely negative years for the stock market which demonstrates the low correlation that alternative investments typically have with both equities and fixed income. Likewise, the S&P 500 was down −37.84% in 2008 and managed futures (Barclay CTA Index) returned 14.09%.

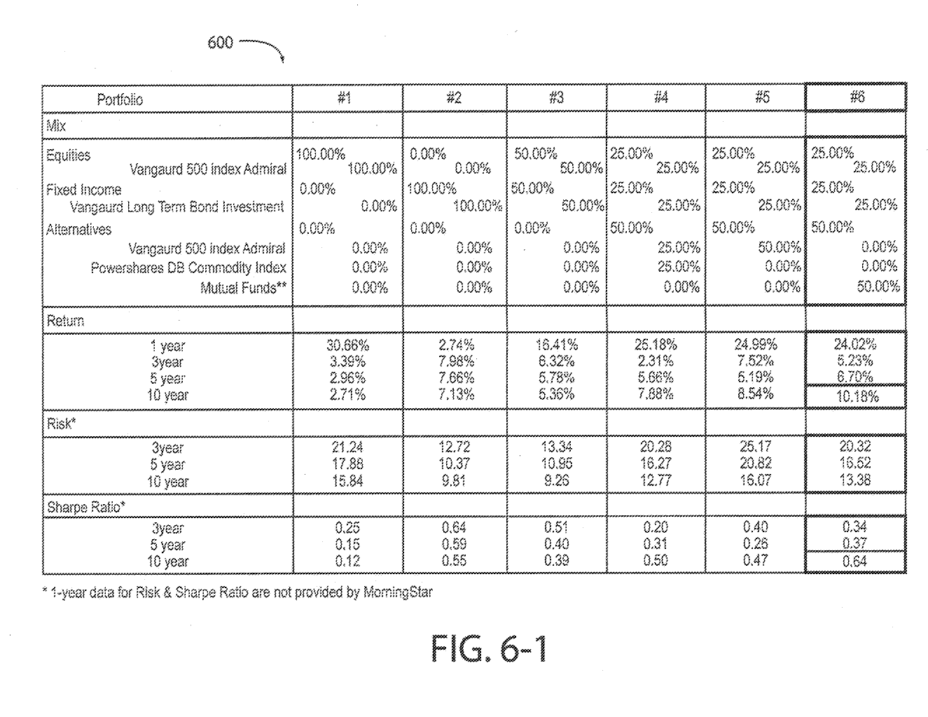

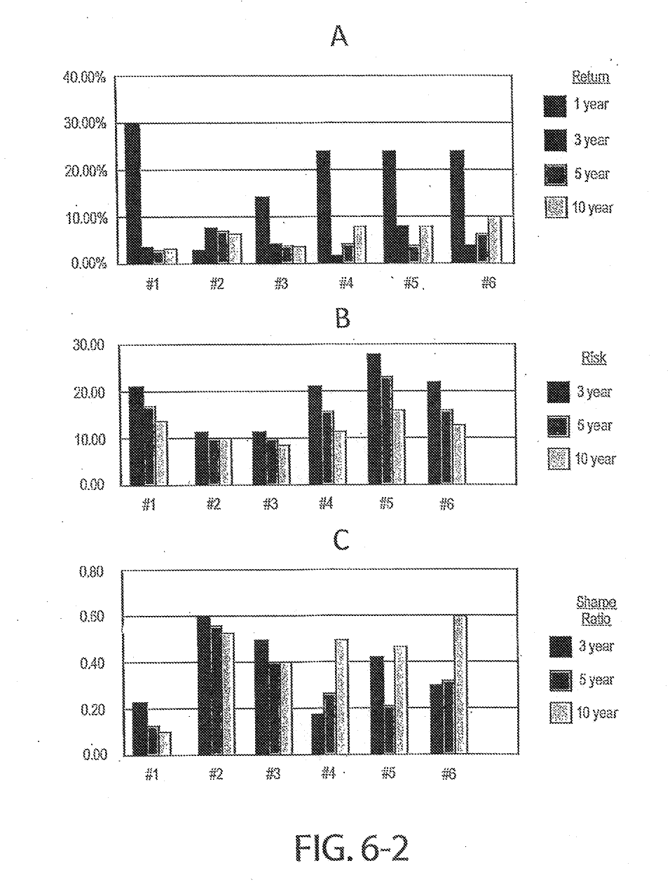

The present system and method are configured to show risk, return, and the Sharpe ratio for each portfolio of equities, fixed income, and alternative investments. Various illustrative Example Portfolios can be structured to compare as illustrated below, and which are also shown in more detail in FIG. 6.

### EXAMPLE PORTFOLIO 1

The first asset allocation (#1) has all equities, no bonds, and no alternative investments. This portfolio did well in the final year but poorly over the other times periods and averaged 2.71% return over the decade. A passive equity index fund was used called Vanguard 500 Index Admiral. Risk was somewhat high and the Sharpe ratio one of the lowest over the times period.

### EXAMPLE PORTFOLIO 2

The second allocation (#2), on the other hand, was comprised of all fixed income and did not include equities or alternative investments. The Vanguard Long-Term Bond Index was used. Over a decade, the index averaged 7.13% return with lower risk and a Sharpe ratio of 0.55.

### EXAMPLE PORTFOLIO 3

The third asset allocation (#3) included 50% fixed income and 50% equities, using the same passive index funds of #1 and #2 allocations. The returns were in between allocations #1 and #2 with averaging a 5.36% return.

### EXAMPLE PORTFOLIO 4

The fourth allocation (#4) used 25% fixed income, 25% equities, and 50% alternatives (25% REIT and 25% Commodities). Passive indexes were selected for the alternative investments. The Vanguard REIT Index was used for REITs and the Powershares DB Commodity Index was used for commodities. The returns for allocation (#4) surpassed the previous combinations of all stock, all bonds, or a 50% stock/50% bond combination with the new stock, bond, and alternative portfolio averaging 7.88% over the decade. While the 3 year number underperformed, all other time periods did well including the 1 year return of 25.18%. Further, risk was 12.77 as opposed to equities 15.84 and a little higher than bonds which had a risk of 9.81. The sharpe ratio was also high with 0.50 compared to only 0.12 for equities and comparable to bonds with 0.55.

### EXAMPLE PORTFOLIO 5

The fifth allocation (#5) used 25% equities, 25% fixed income, and 50% REITs. Despite the collapse of the real estate market in the later part of the decade, the diversified portfolio with the addition of an alternative investment, produced a 24.99% return over 1 year, 7.52% return over 3 years, 5.19% over 5 years, and 8.54% return over 10 years. While returns and the sharpe ratio were higher, risk also increased.

### EXAMPLE PORTFOLIO 6

The sixth allocation (#6) used 25% equities, 25% fixed income, 50% alternatives. Diversification of the portfolio with the addition of an alternative investment, produced 24.02% return over 1 year and a 10.18% return over 10 years. While returns and the Sharpe ratio were higher in this portfolio, risk decreased compared to a portfolio with no alternative,

The alternative mutual funds selected involve different types of alternative investments. The following criteria were used in the above illustrative examples to narrow the list:

### EXAMPLE

### Criteria Used for Selecting Alternative Mutual Funds

1. Each Alternative Mutual Fund must be at least 10 yrs old as of Dec. 29, 2010

2. Each Alternative Mutual Fund must be load-waived

3. Each Alternative Mutual Fund must not be an inverse

4. Each Alternative Mutual Fund must belong to one of the following Morningstar categories:
i. Natural Resources
ii. Real Estate
iii. Global Real Estate Commodities
iv. Currency
v. Long-Short Equity Precious Metals
vi. Bear-Market
vii. Market-Neutral

### Financial Analysis and Investment Policy Statement

Financial analysis starts with what an institutional or individual investor owns at a given point in time. What is the size of the portfolio and how is it broken down. That is, what is the percentage of the overall asset allocation? How many stocks, bonds, and alternative investments does one own? Are there any alternative investments? How are they allocated? What vehicles are being used such as money managers, indexes, ETFs, mutual funds, or hedge funds? Understanding which alternative investment to add and when to add one is no easy task. Neither is selling or eliminating an alternative investment. Alternative investments can play a role in any portfolio since they are different from bonds (fixed income) and stocks (equities). In other words, they have similar characteristics in some respects but do not necessarily correlate with these traditional asset classes. Alternative investments generally have a low correlation with both equities and fixed income.

Whereas financial analysis shows where an investor is at the moment, an investment policy statement shows the direction one is headed or the goals that an investor would like to achieve. An investment policy statement (IPS) details how the investments should be managed, acceptable risk, asset allocation, restrictions, and other mandates they feel are important. Therefore, an investment policy statement contains information that helps one develop a map or course for an investment portfolio to achieve specific goals. An investment policy statement states the steps needed to reach ones goals and objectives. The particular weightings to various alternative investments such as silver, gold, real estate, venture capital, managed futures, and other alternatives illustrates where certain percentages of alternatives are used in an overall coherent asset allocation model with stocks and bonds to build a better portfolio.

In one embodiment of the invention, the system is configured with means of generating an investment policy statement. The investment statement policy is a collection of data related to investor information, investor goals, risk tolerance and other information about a specific portfolio to be allocated. The statement may comprise identifying information, such as investor information, advisor information, manager information, account information, risk tolerance information, or any information stored or collected for use in calculating an asset allocation.

In one embodiment, the investment policy statement may be presented via an interface on an electronic device, such as on a client terminal. The investment policy statement may comprise one or more data entry fields for collecting information, wherein the collected information is then indexed and stored in a database.

In one embodiment, for illustration purposes, a user of the system is presented on the display unit of a computing device with means of collecting information related to the user's goals and objectives for an investment portfolio. Information collected may include:

Personal Information:

Name

Address

Age

Income

Expenses

Are you an institutional investor or individual investor?

Inventory of Present Assets:

Current assets under management?

Percentage of assets are equities

Classification of equities

Percentage of your assets in fixed income

Classification of fixed income assets

Alternative investments owned

Hedge Funds owned

Other Information:

How much do you have invested in hedge funds?

What type of hedge funds are they?

Do you own commodities?

What are they?

How much do you have invested in commodities?

What type of commodities are they?

Do you own venture capital?

What do you own?

Do you own leveraged buyout funds?

What are they?

Do you own managed futures?

What do you own?

Do you own real estate?

What do you own?

Risk Measurement

Risk Tolerance

The information collected as part of the investment policy statement is then transferred to a database for storage in association with a unique identifier for later analysis by the analytics modules of the present invention. All or a portion of the data may be used in analysis, depending on the particular analytics engine. The investment policy statement is stored as an electronic record and is configured for updating as investor information or needs change over time.

### Asset Selection

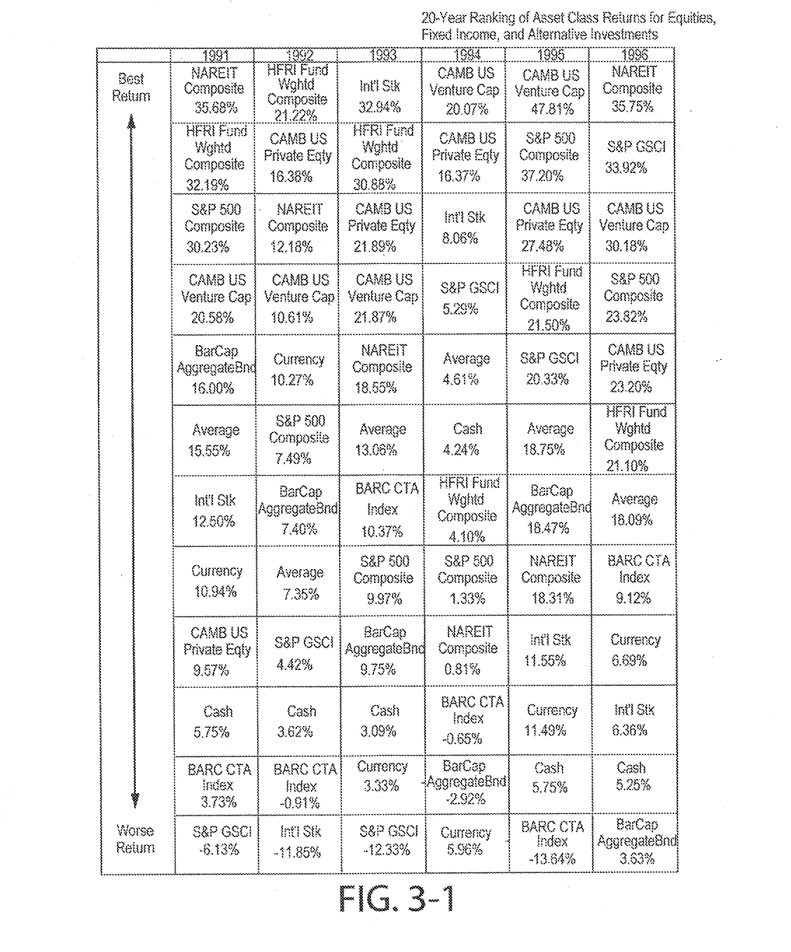

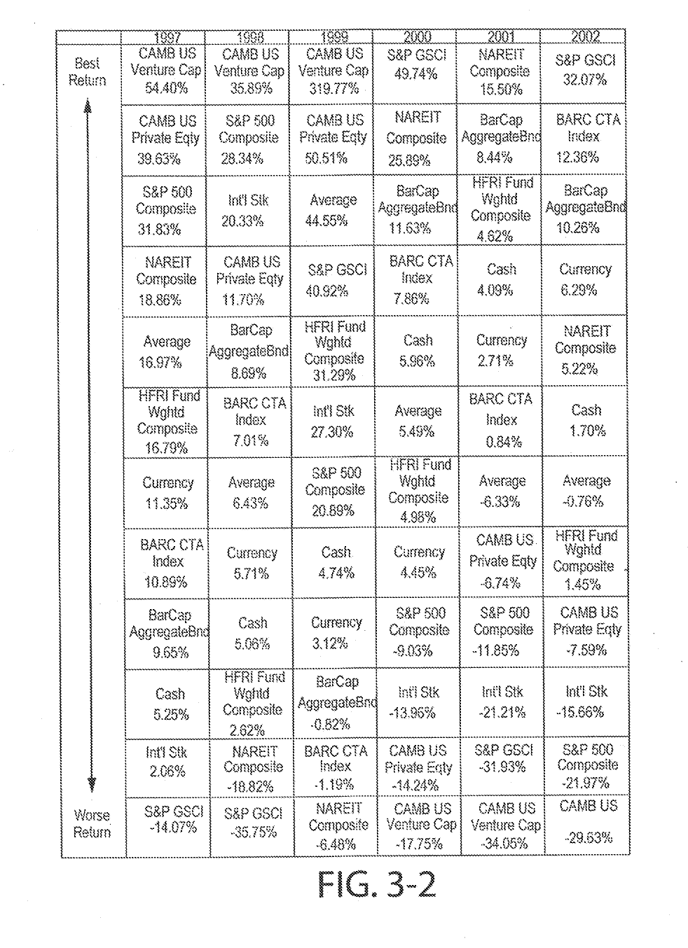

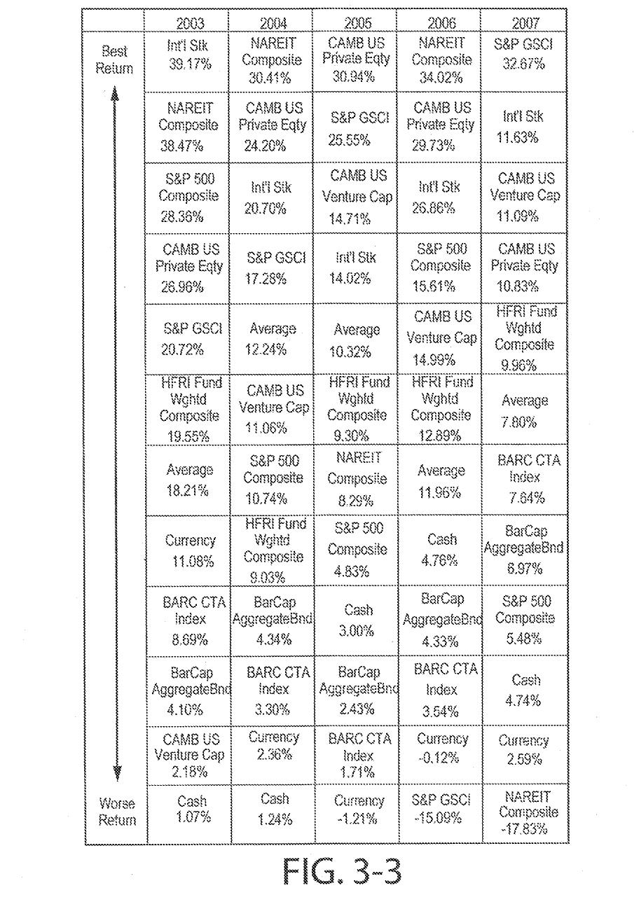

In one embodiment, the system is configured to consider waves, and rank investments by order in which they are likely to appear in the future, based on historical data. Waves are found among all asset classes, including alternative investments. In other words, there are distinct waves found within alternative investments. While there is no way to accurately predict the future, alternatives move in distinct waves, patterns, and trends—as depicted by the chart shown in FIG. 3. The historical data shown in the chart is stored in the system database and used in asset allocation.

In one embodiment, the system is configured with an allocation engine. The allocation engine considers information supplied in the investment policy statement in order to calculate a representative combination of assets, comprised of an equities variable (E), a fixed income variable (F), and an alternative investment variable (A), wherein the variables may be represented by a percentage of a whole, or as a weighted variable (or ratio). For example: a representative combination of assets may be calculated, based on the information in the statement at: 30E; 50F; and 20A, thereby corresponding to an asset allocation of 30% equities, 50% fixed income and 20% alternatives within an investment portfolio. In one embodiment, asset allocation information is stored in a database, and may be stored in association with the policy statement.

In one embodiment, the allocation engine resides on a database in communication with the client terminal. The database may also reside on a remote server, such as a cloud server. In another embodiment, the allocation engine utilizes the data contained in the identified chart.

### Manager Selection Tool

Once an investor or advisor has a suitable asset allocation with alternative investments, managers or securities may be selected that help with this allocation

In one embodiment, the system is configured with a management selection tool. Utilizing a database compiled with a listing of investment managers, a query is sent to the database, and based on one or more selection criteria, one or more possible managers are identified for alternative asset selection. Depending on variables initially identified in the investment policy statement, active (mutual fund manager, money manager, hedge fund manager, or any other active form of managing money), passive (indexes or ETFs that are not actively managed), or a combination of these investments is produced. For example, depending on the asset to which the query is sent, an investment manager may be identified from the database as a suitable manager for that variable of the portfolio. In one embodiment, a query for an investment manager may identify—for example: an active real estate manager, and real estate ETF, or Index (passive investment), depending on the input for the investment policy statement.

### Risk Measuring

In one embodiment, the system is configured for determining the ideal mix of measurable securities based on risk versus return. Newer risk measurements are also incorporated for portfolios using illiquid alternative investments. In one embodiment, risk ratios and correlations are utilized, such as the risk measurement calculations presented in the table below:

TABLE 2

| | | Weight | | | | | | | | |
|---|---|---|---|---|---|---|---|---|---|---|
| | | 20% | 20% | 10% | 10% | 10% | 10% | 10% | 10% | 100% |
| | | | | | | | | | HRFI | |
| | One | | Bar Cap | | | | Comb | BARC | Fund | |
| | Year | | Agg | | S&P | AMB US | US Pvl | CTA | Wghtd | |
| Date | T-Bill | S&P 500 | Bnd | NAREIT | GSCI | Vent Cap | Eqty | Index | Comp | Total |
| 1991 | 5.86 | 30.23 | 16.00 | 35.69 | −6.13 | 20.58 | 9.57 | 3.73 | 32.19 | 18.81 |
| 1992 | 3.89 | 7.49 | 7.40 | 12.18 | 4.42 | 10.61 | 16.38 | −0.91 | 21.22 | 9.37 |
| 1993 | 3.43 | 9.97 | 9.5 | 18.55 | −12.33 | 21.87 | 21.89 | 10.37 | 30.88 | 13.07 |
| 1994 | 5.32 | 1.33 | −2.92 | 0.81 | 5.29 | 20.07 | 16.37 | −0.65 | 4.1 | 4.28 |
| 1995 | 5.94 | 37.2 | 18.47 | 18.31 | 20.33 | 47.81 | 27.48 | −13.64 | 21.5 | 23.31 |
| 1996 | 5.52 | 23.82 | 3.63 | 35.75 | 33.92 | 30.18 | 23.3 | 9.12 | 21.1 | 20.83 |
| 1997 | 5.63 | 31.83 | 9.65 | 18.86 | −14.07 | 54.4 | 39.63 | 10.89 | 16.79 | 20.95 |
| 1998 | 5.05 | 28.34 | 8.69 | −18.82 | −35.75 | 35.89 | 11.7 | 7.01 | 2.62 | 7.67 |
| 1999 | 5.08 | 20.89 | −0.82 | 6.48 | 40.92 | 319.77 | 50.51 | −1.19 | 31.29 | 47.50 |
| 2000 | 6.11 | −9.03 | 11.63 | 25.89 | 49.74 | −17.75 | −14.24 | 7.86 | 4.98 | 6.17 |
| 2001 | 3.49 | −11.85 | 8.44 | 15.5 | −31.93 | −34.05 | −6.74 | 0.84 | 4.62 | −5.86 |
| 2002 | 2.00 | −21.97 | 10.26 | 5.22 | 32.07 | −29.63 | −7.59 | 12.36 | −1.45 | −1.24 |
| 2003 | 1.24 | 28.36 | 4.10 | 38.47 | 20.72 | 2.18 | 26.96 | 8.69 | 19.55 | 18.15 |
| 2004 | 1.89 | 10.74 | 4.34 | 30.41 | 17.28 | 11.06 | 24.2 | 3.3 | 9.03 | 12.54 |
| 2005 | 3.62 | 4.83 | 2.43 | 8.29 | 25.55 | 14.71 | 30.94 | 1.71 | 9.3 | 10.50 |
| 2006 | 4.94 | 15.61 | 4.33 | 34.02 | −15.09 | 14.99 | 29.73 | 3.54 | 12.89 | 12.00 |
| 2007 | 4.53 | 5.48 | 6.97 | −17.83 | 32.67 | 11.09 | 10.83 | 7.64 | 9.96 | 7.93 |
| 2008 | 1.83 | −36.58 | 5.24 | −37.84 | −46.49 | −17.36 | −23.63 | 14.09 | −19.02 | −19.29 |
| 2009 | 0.47 | 25.92 | 5.93 | 27.8 | 13.48 | 6.28 | 21.74 | −0.1 | 19.98 | 15.29 |
| 2010 | 0.32 | 15.06 | 6.54 | 27.56 | 9.02 | 18.51 | 21.45 | 7.05 | 10.49 | 13.73 |
| 2011 | 0.18 | 0.00 | 4.62 | 7.28 | 2.07 | 11.18 | 10.90 | −3.09 | −5.56 | 3.40 |
| Average | 3.64 | 10.37 | 6.89 | 13.31 | 6.94 | 26.40 | 16.26 | 4.22 | 12.21 | 11.38 |
| Std. Dev. | 2.01 | 18.94 | 4.94 | 20.39 | 26.05 | 70.84 | 17.75 | 6.40 | 12.78 | 12.89 |
| (Pulled from | | | | | | | | | | |
| First Sheet) | | | | | | | | | | |
| Downside Dev. | | 10.20 | 2.16 | 10.73 | 15.30 | 11.72 | 7.26 | 4.46 | 4.64 | 4.94 |
| Beta | | | 0.04 | 0.56 | 0.20 | 1.35 | 0.74 | −0.12 | 0.50 | 0.34 |
| Alpha | | | 6.59 | 9.55 | 5.62 | 17.34 | 11.27 | 5.03 | 8.83 | 7.78 |
| Sharpe Ratio | | 0.36 | 0.66 | 0.47 | 0.13 | 0.32 | 0.71 | 0.09 | 0.67 | 0.60 |
| Sortino Ratio | | 0.00 | 1.51 | 0.90 | 0.22 | 1.94 | 1.74 | 0.13 | 1.85 | 1.57 |
| Treynor Ratio | | | 73.08 | 17.32 | 16.90 | 16.90 | 17.02 | −4.84 | 17.06 | 14.47 |
| | | | | | | | | | HRFI | |
| | One | | Bar Cap | | | | Camb | BARC | Fund | |
| | Year | | Agg | | S&P | AMB US | US Pvt | CTA | Wghtd | |
| | T-Bill | S&P 500 | Bnd | NAREIT | GSCI | Vent Cap | Eqty | Index | Comp | Total |
| (1) One Year T- | | 0.29 | 0.25 | −0.01 | 0.09 | 0.25 | 0.15 | −0.13 | 0.35 | 0.32 |
| Bill | | | | | | | | | | |
| (2) S& P 500 | | | 0.19 | 0.40 | 0.14 | 0.17 | 0.72 | 0.15 | 0.75 | 0.78 |
| (3) Bar Cap Agg | | | | 0.20 | −0.10 | −0.30 | −0.28 | −0.08 | 0.19 | −0.05 |
| Bnd | | | | | | | | | | |
| (4) NAREIT | | | | | 0.30 | −0.16 | 0.34 | −0.14 | 0.55 | 0.38 |
| (5) S&P GSCI | | | | | | 0.27 | 0.26 | −0.17 | 0.31 | 0.49 |
| (6) AMB US | | | | | | | 0.64 | −0.27 | 0.47 | 0.79 |
| Vent Cap | | | | | | | | | | |
| (7) Camb US | | | | | | | | −0.35 | 0.68 | 0.85 |
| Pvt Equity | | | | | | | | | | |
| (8) BARC CTA | | | | | | | | | −0.25 | −0.34 |
| Index | | | | | | | | | | |
| (9) HRFI Fund | | | | | | | | | | 0.82 |
| Wghtd Comp | | | | | | | | | | |
| (10) Total | | | | | | | | | | |

Because risk tolerance varies amongst investors, the system is configured with a risk tolerance engine, which may be considered and executed by the allocation engine, or may be performed as a separate (stand-alone) risk analysis step. In one embodiment, the risk tolerance parameters used are as follows: Var, Cvar, Mvar, and McVar; depending on the risk tolerance identified. In another embodiment, when a risk tolerance is identified in the policy statement, the appropriate risk tolerance parameter will be applied by the allocation engine, thereby adjusting the asset allocation by adjusting the ratio of E:F:A.

In one embodiment, the system is configured to measure a value at Risk (VAR): Value at Risk or VaR is a measure of risk and is utilized by the system to estimate the probability of portfolio losses based on the statistical analysis of historical price trends and volatilities. There are different types of VaR or Value at Risk.

In another embodiment, the system is configured to measure a modified Value at Risk (MVAR): Because VaR is based on normally distributed returns, which is somewhat unrealistic, newer variations of VaR have evolved such as MVaR (or Cornish Fisher Value-at-Risk). MVaR is basically a generalization of VaR that allows for the returns distribution to be both skewed and have excess kurtosis. Returns are non-normal and MVaR takes this into consideration by allowing the distribution to be skewed and have excess kurtosis (which is referred to as the third and fourth moments of the distribution). MVaR is a more realistic risk measurement. MVaR can be helpful with alternative investments.

In yet another embodiment, the system is configured to measure a CVaR (Conditional Value at Risk), which provides an estimate of risk taking into consideration extreme losses in the tail. Conditional Value-at-Risk (CVaR) can be viewed as the tail VaR or expected tail loss. CVaR focuses on the left tail. CVaR is similar to VaR but somewhat more comprehensive and does not just look at one point of distribution. CVaR takes a probability-weighted average of the possible losses conditional on the loss being equal to or exceeding the specified VaR. CVaR, however, might be a better way to measure risk. CVaR takes into consideration the non-normal nature of returns, unlike VaR. Regardless of whether one prefers basic VaR or conditional VaR, there will always be risk.

In yet another embodiment, the system is configured to measure M-CVaR (Modified-Conditional Value-at-Risk): The majority of asset classes have returns that are not normally distributed. Return distribution is skewed to the left or right of the mean or expected value. M-CVaR maximizes return for a given level of CVaR, or equivalently, minimizes CVaR for a given level of return. Conditional value-at-risk (CVaR) measures the expected loss in the left tail given (i.e. conditional on) that a particular threshold has been met, such as the worst 1st or 5th percentile of outcomes in the distribution of possible future outcomes.” Ideally, the dream investment is leptokurtic with positive skewness and has low semi-variance.

The system and method of the present invention are configured to identify and show various risk measurements for alternative investments. Below is a sample over a 20-year period, examining a number of VaR Calculations (VaR, CVaR, and MvaR) as well as standard deviation and average returns.

TABLE 3
Percentile 5.0%

| | Monthly | | | | | | Quarterly | | | | | |
|---|---|---|---|---|---|---|---|---|---|---|---|---|
| | | | | | VaR | | | | | VaR | | |
| | | Returns | | | Calcul | n | | Returns | | Calculns | | |
| | Weights | Average | Std Dev | VaR | cVaR | mVaR | Weights | Average | Std Dev | VaR | cVaR | mVaR |
| S&P 500 | 20% | 0.80% | 4.35% | −6.36% | −8.98% | −6.17% | 20% | 2.47% | 8.25% | −11.10% | −17.01% | −10.78% |
| S&P GSCI | 20% | 0.61% | 6.04% | −9.33% | −12.47% | −8.97% | 10% | 1.96% | 11.26% | −16.57% | −23.23% | −15.50% |
| Barclays | 20% | 0.57% | 1.07% | −1.20% | −2.22% | −1.18% | 20% | 1.71% | 2.00% | −1.58% | −4.12% | −1.59% |
| Capital | | | | | | | | | | | | |
| Aggregate | | | | | | | | | | | | |
| Bond | | | | | | | | | | | | |
| Barclay | 10% | 0.47% | 2.32% | −3.36% | −4.79% | −3.29% | 10% | 1.38% | 3.54% | −4.43% | −7.29% | −4.37% |
| CTA Index | | | | | | | | | | | | |
| NAREIT All | 10% | 1.12% | 5.72% | −8.30% | −11.81% | −7.16% | 10% | 3.44% | 10.43% | −13.72% | −21.51% | −12.39% |
| Equity | | | | | | | | | | | | |
| REITS | | | | | | | | | | | | |
| Cambridge | 0% | | | | | | 10% | 4.45% | 12.62% | −16.31% | −26.03% | −7.98% |
| US | | | | | | | | | | | | |
| Venture | | | | | | | | | | | | |
| Capital | | | | | | | | | | | | |
| Cambridge | 0% | | | | | | 10% | 3.63% | 5.26% | −5.03% | −10.85% | −4.73% |
| US Private | | | | | | | | | | | | |
| Equity | | | | | | | | | | | | |
| HRFI Fund | 20% | 0.93% | 2.05% | −2.43% | −4.22% | −2.29% | 10% | 2.72% | 4.39% | −4.50% | −9.05% | −4.31% |
| Wghtd | | | | | | | | | | | | |
| Comp | | | | | | | | | | | | |
| Portfolio | 100% | 0.74% | 2.30% | −3.05% | −4.75% | −2.70% | 100% | 2.59% | 4.20% | −4.32% | −8.66% | −3.93% |

The percentile used for this example using data from the past 20 years (1991-2011) is 5%. The probability level for the VaR and CVaR is set at 5% with a confidence level of 95%. Approximately 5% of the time, the S&P500 shows that the S&P500 index (using VaR) will produce returns at least −6.36% on a monthly and −11.10% on a quarterly basis. During 2008, the S&P500 had a total of 8 negative months of returns throughout the year. There were 2 times, the index produced back to back negative returns 3 months in a row.

The standard deviation in both the monthly and quarterly columns shows how much variability is in distribution. Just like with bonds and stocks, alternative investments vary. One example is venture capital. The return distribution skews to the right of the mean (or expected value) because there are blockbuster quarters which in turn pull up the average. Regarding using VaR, at 5% when things are bad, what is the threshold if one examines the past 20 years? If one looks at the VaR for REITs, it was −13.72%. Using CVaR, it was −21.51%. The Real Estate REIT index that was used was the NAREIT index, an unmanaged total return index that is designed to measure the growth and performance of the REIT industry. The index includes all REITs currently trading on the New York Stock Exchange, the NASDAQ National Market System and the American Stock Exchange. Source: National Association of Real Estate Investment Trusts, Inc. If a 5% extreme event occurs, what would you expect to lose if one had all REITs. In 1987, for example, the market was decimated, It was a 6 sigma event. When that happens, what is the average negative return? What might an investor expect? MVaR was created, which assumes returns are not normal and that the tails are fatter. There is a higher degree or number of losses with a “fat tail” return distribution. Using REITs again as an example, MVaR would be around −1239%. The standard deviation for REITs over this time period is 10.43% with average returns of 3.44%. One can compare these numbers to equities, fixed income, and other alternative investments to achieve a better asset allocation model.

### Behavioral Finance

In one embodiment, the system is configured with means for assessing market sentiment and market volatility.

Alternative investments, like stocks and bonds, have varying rates of return and levels of price volatility over time. The system is configured to examine market sentiment using the following:

A. The VIX index for short investments. VIX is a volatility index. It measures market sentiment sometimes referred to as the “fear index.” The VIX-index is based on historic data. Depending on where the index is at any given moment, alternative investments may or may not be desirable. This index is utilized by the system of the present invention.

B. Natural Language Processing Technology to capture sentiment, such as sentiment data. In one embodiment, sentiment data is collected as Twitter data for securities and the market. This data is then stored in a database for use by the system of the present invention.

C. Relative Strength Index-For other short term investments involving REITs, the Relative Strength Index is used. Relative strength index is a technical indicator known as a momentum oscillator used in the analysis of a stock or market based on closing prices of a recent trading period. RSI charts the current and historical strength or weakness of a market or security. In one embodiment, RSI is utilized when considering REITS, and may also be consider for the general market as well as commodity ETFs like gold or oil. RSI is used for short term or tactical investments and is most typically used on a 14 day timeframe measured on a scaled from 0 to 100 with a high and low levels marked 70 and 30 respectively.

### Fibonacci Engine

In one embodiment, the system is configured with a Fibonacci analysis engine. As examples, Fibonacci analysis might be used for the Dow Jones, Nasdaq, Oil, REIT index, Commodity Index, etc. Fibonacci analysis is used primarily for short term or tactical changes to the asset mix, such as the daily close of a public security measured over time.

Fibonacci numbers can be used when making investments in alternative investments such as ETFs or individual equities of companies involved with commodities including but not limited to oil, corn, gold, and others.

Fibonacci numbers to draw retracement lines after a bullish or bearish trend to give them an idea of where they can expect to find support and resistance levels in financial series.

### Portfolio Construction

The system is configured to generate a portfolio construction. In one embodiment, the portfolio construction is comprised of asset allocation data in the form of a table indicating the ratio for each asset, or percentage of each asset, within the portfolio. In another embodiment, the portfolio construction is comprised of asset allocation data in the form of a pie chart, or other graphical representation. In one embodiment, the data of the portfolio construction is stored in a database for later retrieval, thereby creating an electronic record of the portfolio construction.

In one embodiment, the system is configured for both tactical (short term investing) as well as strategic (long term investing). Tactical asset allocation is a dynamic investment strategy that changes a portfolio's assets over shorter time period in order to lower risk and increase returns. Alternative investments, just like stocks or bonds, can be added to a portfolio with a short term or longer term view, or even a combination of the two. In other words, one can have a long term portfolio with assets they intend to hold for the long haul while adding or selling other alternative investments on a short term basis. An investor might have a short term allocation to alternative investments (IPOs, private equity, ETFs, real estate REITs, etc.) and a longer term asset allocation (venture capital, real estate, timber, hedge funds, LBO, etc.) that they add to a stock and bond portfolio. By diversifying with different types of alternatives and adding them to a stock and bond portfolio, it might lower risk and increase returns. Just by adding more securities, whether they are alternative investments or not, does not necessarily mean one is lowering risk. The system analyzes using short term of tactical investments for a portfolio to take advantage of market conditions. Generally, ETFs can be utilized such as for buying Gold (GLD). Alternative investments are a different breed from equities and bonds. Security selection and manager selection is extremely important.

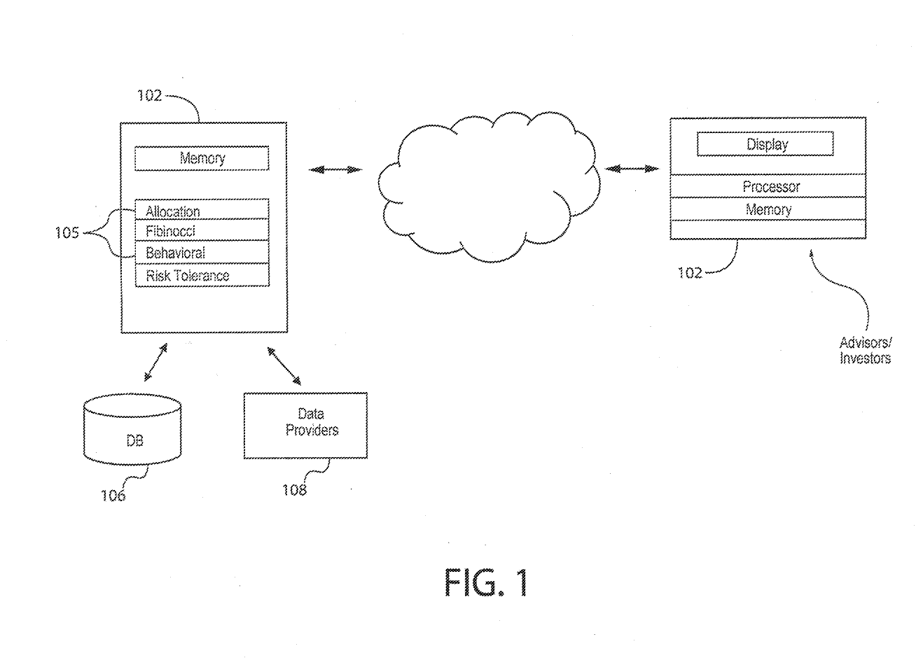

Turning now to the Figures, which show additional embodiments of the present invention. FIG. 1 shows an overview of an exemplary system 100 according to one embodiment of the invention in which a client terminal 102 configured with memory and a processing unit is connected over a network, such as a wireless network, to a processing unit 104 configured with memory and one or more databases (105), whereon are stored various analytics modules including but not limited to: an allocation engine; a Fibonacci analysis engine; a behavioral analysis engine; a risk tolerance analysis engine. In another embodiment, analytics modules may reside on one or more database servers (for example, database 106) remote from processing unit 104. Client terminal 102 is further configured with memory, processing means, and input means for receiving information associated with the investment policy statement, such as information input by a user, including an investor, manager, or advisor. Client terminal 102 is further configured for display of a portfolio construction (not shown), The system is configured with one or more external data sources, such as an investment manager directory database 108 and databases comprising financial data from third party sources (not shown) may also be associated with the system, and in communication with processing unit 104 and/or client terminal 102.

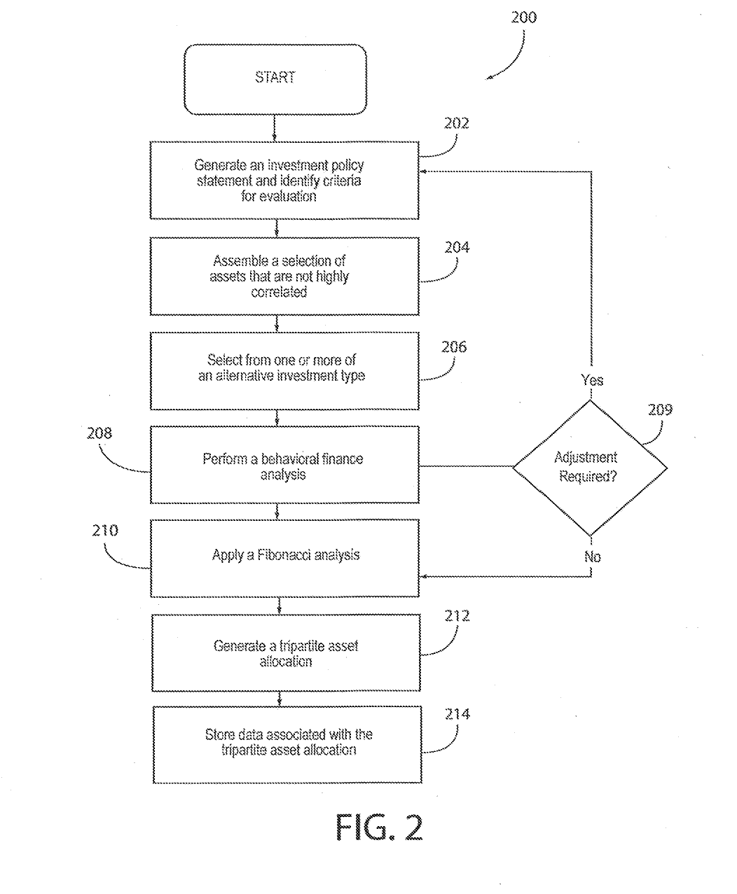

FIG. 2 shows an exemplary process flow diagram illustrating embodiments of a method 200 for generating an asset allocation.

At step 202 an investment policy statement is generated by receiving input via a client terminal that identifies one or more data fields for collecting data, such as: data related to investor information; data related to asset information; data related to risk tolerance, or any other necessary information in order to perform an asset allocation analysis.

Step 202 may also include a risk measurement component, which in turn is considered when assets are allocated.

At step 204, based on the information and data of the investment policy statement, a plurality of assets are assembled, wherein the assets are one that are not highly correlated. In one embodiment, the assets may be comprised of equities (E), fixed income (F), and alternative investment (A) assets.

At step 206, based on the investment policy statement, one or more of an alternative investment is selected.

At step 208 a behavioral analysis is performed by comparing market factors, including market volatility, to the investment policy statement.

At step 209, depending on the results of the behavioral analysis, an adjustment is made to the assets assembled in order to bring the asset selection more in line with behavioral attributes in line with the investment policy statement.

At step 210 a Fibonacci analysis is applied which in turn generates a strategic allocation of assets category and a tactical allocation of assets category within the allocation of assets comprised of alternative investments (A).

At step 212, the results of the analysis are tabulated and a tripartite asset allocation is generated, comprised of E, F and A in varying amounts relative to each other.

At step 214, data associated with the tripartite asset allocation is stored as an electronic record. The data may also be represented in graphical form and displayed on the display screen of the client terminal.

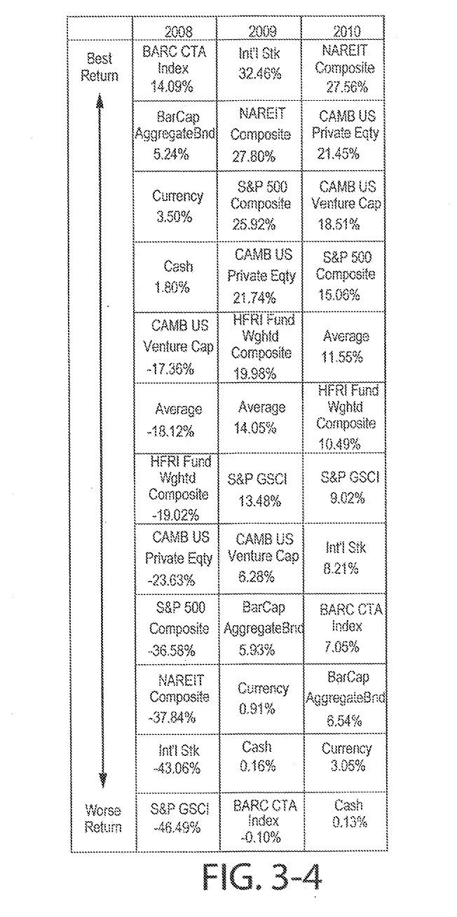

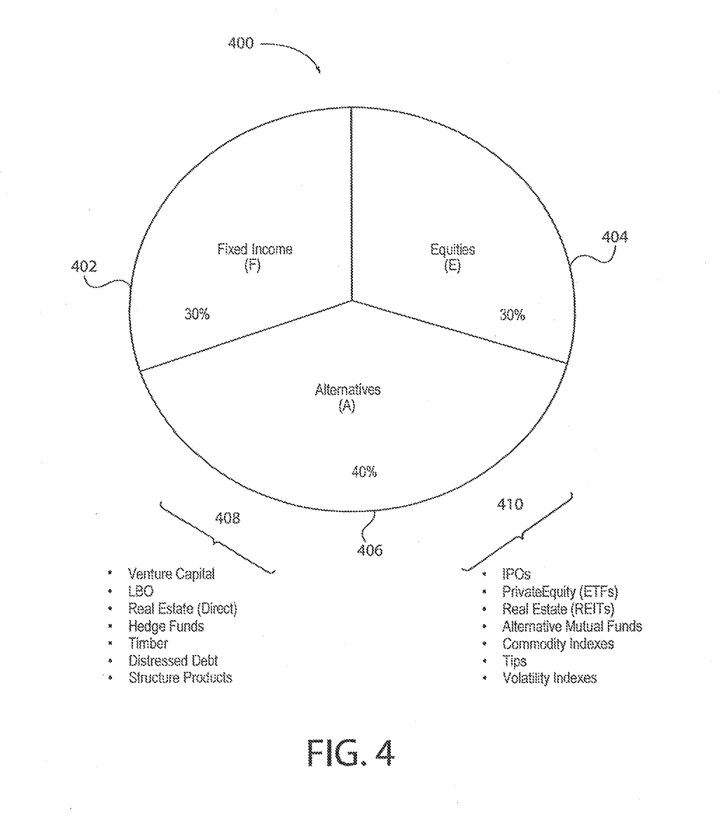

FIG. 3 shows a collection of historical data 300 for use by the allocation engine of system 100 according to one embodiment of the invention. The historical data 300 shows a 20-year ranking of asset class returns for equities (E), fixed income (I) and alternative investments (A), with the best returns being listed at the top on the chart and the worst returns being listed below. In one embodiment, the data is stored in a table or index on a database within the processing unit 104, or on a remote database 106 in communication with processing unit 104. FIG. 3-1 shows years 1991-1996 with the best returns along the top portion of the table (per column, per year) and decreasing to the worst returns per year. FIG. 3-2 shows years 1997-2002 with the best returns along the top portion of the table (per column, per year) and decreasing to the worst returns per year. FIG. 3-3 shows years 2003-2007 with the best returns along the top portion of the table (per column, per year) and decreasing to the worst returns per year. FIG. 3-4 shows years 2008-2010 with the best returns along the top portion of the table (per column, per year) and decreasing to the worst returns per year.

FIG. 4 shows an exemplary portfolio construction 400 comprised of tripartite asset allocation, wherein method 200 generates an asset allocation of fixed income (F) 402, equities (E) 404 and alternative investments (A) 406, wherein alternative investment comprise both a strategic asset allocation 408 and a tactical asset allocation 410.

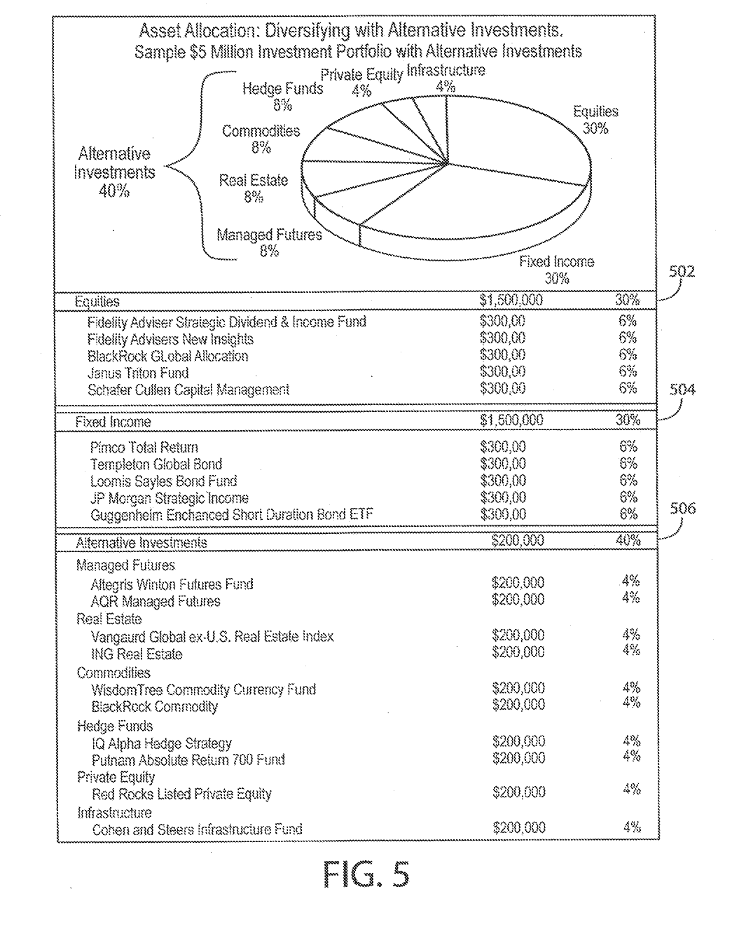

FIG. 5 shows an exemplary asset allocation 500 according to one embodiment of the present invention, in which a sample $5 million investment portfolio is generated based on the system and method of the present invention. Tripartite asset allocation shows a mix of equities 502, fixed income 504 and alternatives 506, with various assets within the asset class listed in tabular form. These specific assets may be identified by the system, or alternatively, by a manager selected by the manager selection tool of the system.

FIG. 6 shows an exemplary portfolio asset allocation 600 corresponding to the Example Portfolios described herein, wherein return, risk and Sharpe ratio have been quantified by the system. FIG. 6-1 is a tabular depiction of a portfolio allocation for the Example Portfolios 1-6 presented herein, broken down as a percentage of equities, fixed income, alternatives, return, risk and Sharpe ratio, also presented in tabular form in FIG. 6-2. FIG. 6-2A is a graphical depiction of an exemplary return utilizing the invention at 1 year, 3 years, 5 years and 10 years for each of the Example Portfolio's 1-6 presented herein. FIG. 6-2B is a graphical depiction of an exemplary risk tolerance utilizing the invention at 3 years, 5 years and 10 years for each of the Example Portfolios 1 through 6 presented herein. FIG. 6-2C is a graphical depiction of a Sharpe ratio utilizing the invention at 3 years, 5 years and 10 years for the Example Portfolios 1-6 presented herein.

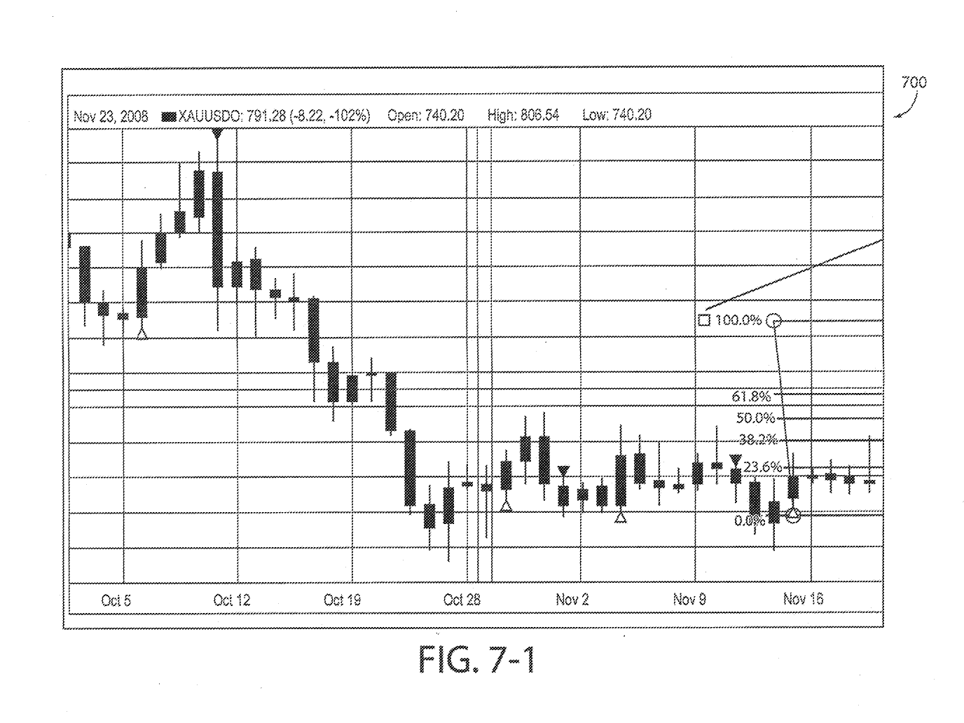

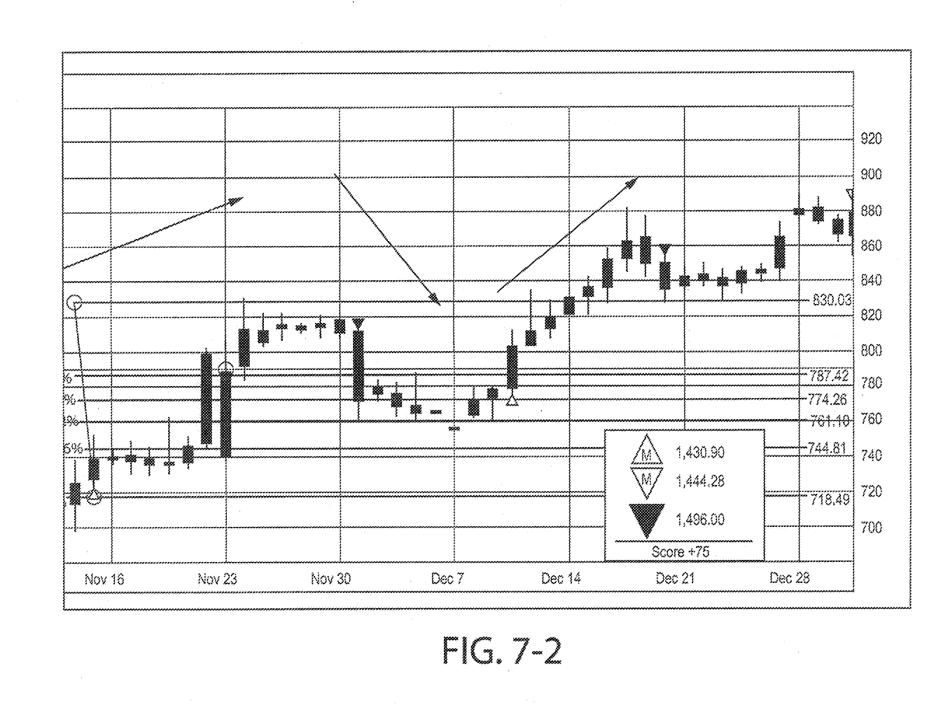

FIG. 7 shows an exemplary Fibonacci analysis model 700. A Fibonacci tool is used to trace a slight uptrend that occurs between the dates of Nov. 14, 2008 and Dec. 1, 2008 for gold on the FOREX. FIG. 7-1 shows an exemplary Fibonacci analysis of Gold on the FOREX at a time period, October 5-November 16. FIG. 7-2 shows an exemplary Fibonacci analysis of Gold on the FOREX extending the analysis from FIG. 7-1 through December 28. The tool draws retracement lines in proportion to the Golden ratio from the beginning of the trend to its end, indicating that possible reversals might take place at prices that are 1.236, 1.382, 1.5 and 1.618 times 758.49. In this example the Fibonacci Tool's retracements seem to agree with a resistance level that occurs at 1.5 the starting price of the uptrend, 761.1. After the price reflects off of the retracement level, it can be expected that the original bull trend will continue; an example of a Fibonacci Retracement.

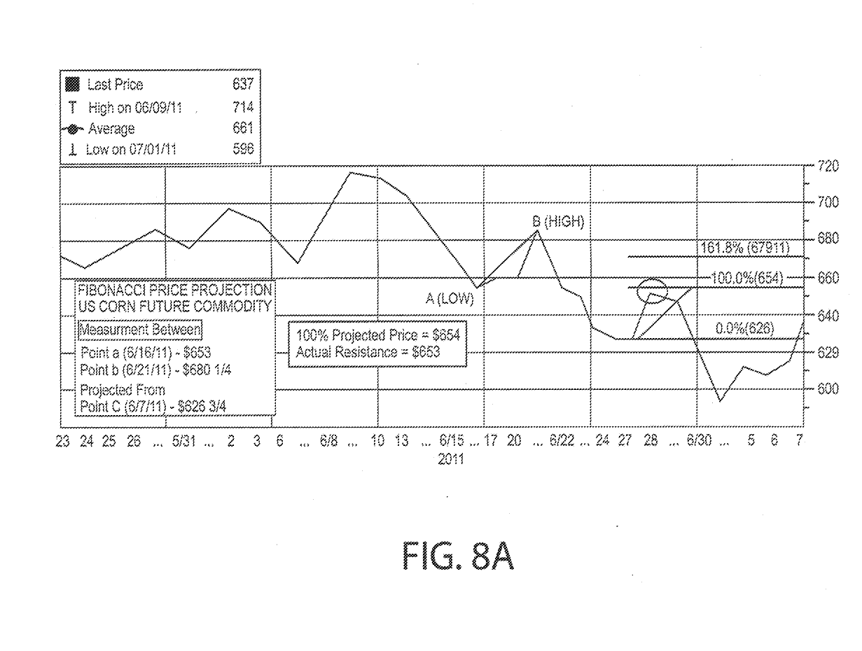

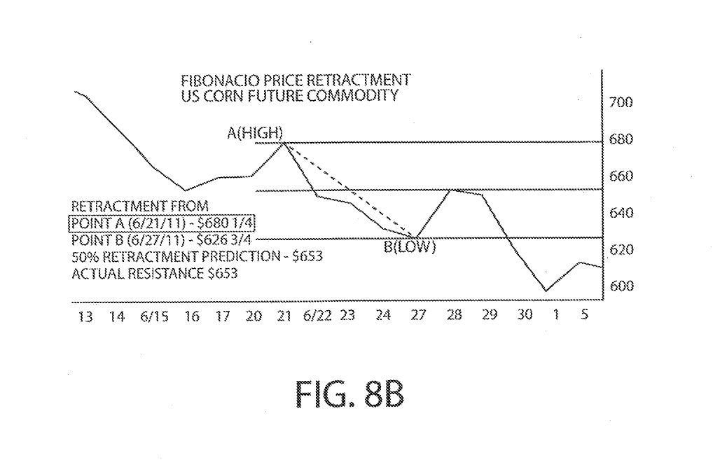

FIG. 8A shows exemplary Fibonacci analysis in which a Fibonacci price projection for U.S. corn measured from the low of $653 to the high of $680, and projected from the low of $626. The 100% projection comes in a $654; the actual high was made at $653. In FIG. 8B shows a Fibonacci price retracement for U.S. corn measured form the high of $680¼to the low of $626¾—the 50.0% retracement predicts a resistance level at $653½, only $0.50 beyond the actual high at $653.

The benefits of the invention described herein will be readily apparent to those skilled in the art. The modular approach of the present invention permits selection of desired alternative investments and behavioral finance for customization to a particular investment objective.

As used herein, a “computer” or “computer system” may be, for example and without limitation, either alone or in combination, a personal computer (PC), server-based computer, main frame, server, microcomputer, minicomputer, laptop, personal data assistant (PDA), smartphone (iPhone, Android), tablet, processor, including wireless and/or wireline varieties thereof, and/or any other portable electronic device capable of configuration for receiving, storing and/or processing data for standalone application and/or over a networked medium or media.

Computers and computer systems described herein may include operatively associated computer-readable media such as memory for storing software applications used in obtaining, processing, storing and/or communicating data. It can be appreciated that such memory can be internal, external, remote (including cloud servers and cloud data storage) or local with respect to its operatively associated computer or computer system. Memory may also include any means for storing software or other instructions including, for example and without limitation, a disc-based media (CD, DVD), memory stick, ROM (read only memory), RAM (random access memory), PROM (programmable ROM), EEPROM (extended erasable PROM), and/or other like computer-readable media.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein. It should be appreciated that the figures are presented for illustrative purposes and not as construction drawings, and are not limiting. Omitted details and modifications or alternative embodiments are within the purview of persons of ordinary skill in the art.

It can be appreciated that, in certain aspects of the present invention, a single component may be replaced by multiple components, and multiple components may be replaced by a single component, to provide an element or structure or to perform a given function or functions. Except where such substitution would not be operative to practice certain embodiments of the present invention, such substitution is considered within the scope of the present invention.

The examples presented herein are intended to illustrate potential and specific implementations of the present invention. It can be appreciated that the examples are intended primarily for purposes of illustration of the invention for those skilled in the art. The diagrams depicted herein are provided by way of example. There may be variations to these diagrams or the operations described herein without departing from the spirit of the invention. For instance, in certain cases, method steps or operations may be performed in differing order, or operations may be added, deleted or modified.

Furthermore, whereas particular embodiments of the invention have been described herein for the purpose of illustrating the invention and not for the purpose of limiting the same, it will be appreciated by those of ordinary skill in the art that numerous variations of the details, materials and arrangement of elements, steps, structures, and/or parts may be made within the principle and scope of the invention without departing from the invention as described in the following claims.

I claim:

1. A system for allocating assets within an investment portfolio, comprising:
a data storage unit for storing data associated with a plurality of assets, including equities, fixed income, and alternative investments;
an investment policy statement, wherein data includes an assembly of investment criteria including a risk tolerance level;
one or more analysis engines within the data storage unit, each analysis engine configured to evaluate criteria of the investment policy statement in order to identify an allocation of assets, wherein the analysis engines comprise a Fibonacci analysis engine, a Monte Carlo simulation, a risk measurement analysis engine, and a behavioral finance analysis engine;
a client terminal for input and display of information associated with the investment policy statement; and
a processing unit in connection with the data storage and the client terminal, wherein information from the investment policy statement is analyzed by one or more of the analysis engines, thereby generating a portfolio construction comprised of a tripartite asset allocation of fixed income, equities, and one or more alternative investments.

2. The system of claim 1, further comprising: means for storing the portfolio construction as an electronic record in a database for later retrieval.

3. A method for allocating assets within an investment portfolio, comprising:
generating an investment policy statement;
assembling, based on criteria identified in the investment policy statement, a selection of assets that are not highly correlated;
selecting from one or more of an alternative investment type for inclusion in the asset allocation;
applying one or more modern risk measurements, wherein risk measurements are calculated; performing a behavioral risk analysis;
applying a Fibonacci analysis; and
compiling the results into a portfolio construction, thereby generating a tripartite asset allocation.

4. The method of claim 3, wherein the portfolio construction may be stored in a database as an electronic record for later retrieval.

5. A non-transitory computer-readable medium having recorded thereon a program that causes a computing device to execute a method for asset allocation within an investment portfolio, the steps in the method comprising: receiving investment criteria identified in an investment policy statement; assembling, based on criteria identified in the investment policy statement, a selection of assets that are not highly correlated; selecting from one or more of an alternative investment type for inclusion in the asset allocation; applying one or more modern risk measurements, wherein risk measurements are calculated; performing a behavioral risk analysis; applying a Fibonacci analysis; and compiling the results into a portfolio construction, thereby generating a tripartite asset allocation, wherein the portfolio construction is presented in graphical or tabulated form on a display unit associated with the computing device.
